(19) United States
(12) Patent Application Publication
(10) Pub. No.: US 2018/0030276 A1
(43) Pub. Date: Feb. 1, 2018

(54) PROCESS TO MODIFY BITUMEN

(71) Applicant: E. I. DU PONT DE NEMOURS AND COMPANY, Wilmington, DE (US)

(72) Inventors: James R. De Garavilla, Silsbee, TX (US); Charles J. DuBois, Orange, TX (US); George Wyatt Prejean, Orange, TX (US); Sara Luisa Reynoso Gomez, Mexico City (MX); Felipe Sanchez-Chavez, San Luis Potosi (MX)

(73) Assignee: E. I. DU PONT DE NEMOURS AND COMPANY, Wilmington, DE (US)

(21) Appl. No.: 15/552,000

(22) PCT Filed: Feb. 26, 2016
(86) PCT No.: PCT/US16/19764

§ 371 Date: Aug. 18, 2017

Related U.S. Application Data
(60) Provisional application No. 62/121,078, filed on Feb. 26, 2015.

(51) Int. Cl. C08L 95/00; C08L 23/08

(52) U.S. Cl. CPC C08L 95/00; C08L 23/0884; C08L 2205/03; C08L 2205/08; C08L 2555/80; C08L 2555/74; C08L 2555/60

(57) ABSTRACT

Provided herein is an asphalt composition comprising or produced from asphalt, a solution of ethylene copolymer dissolved in flux oil or liquid plasticizer, and optionally a sulfur source or acid, wherein the ethylene copolymer comprises repeat units derived from ethylene and from an epoxy-containing comonomer. Further provided are processes for making the solution of ethylene copolymer in flux oil or liquid plasticizer and the asphalt composition comprising or produced from this solution.

### CROSS-REFERENCE TO RELATED APPLICATION

This application claims priority under 35 U.S.C. § 119 to U.S. Provisional Appln. No. 62/121,078, filed on Feb. 26, 2015, which is incorporated herein by reference in its entirety.

### FIELD OF THE INVENTION

Provided herein is a composition comprising or produced from bitumen (asphalt) and an ethylene copolymer solution. The ethylene copolymer solution comprises an ethylene-glycidyl methacrylate copolymer or terpolymer and an oil or a liquid plasticizer. Further provided are methods for preparing the ethylene copolymer solution to obtain lower reaction or processing times and an asphalt composition comprising or produced from this solution.

### BACKGROUND OF THE INVENTION

Several patents and publications are cited in this description in order to more fully describe the state of the art to which this invention pertains. The entire disclosure of each of these patents and publications is incorporated by reference herein.

Some asphalt sold for paving is modified with polymers to improve rut resistance, fatigue resistance, or cracking resistance. Moreover, modification with polymers can improve stripping resistance (from aggregate) resulting from increases in asphalt elasticity and stiffness. Asphalts are performance graded (PG) by a set of specifications developed by the U.S. federal government (Strategic Highway Research Program or SHRP). For example, PG58-34 asphalt is so designated because it provides good rut resistance at 58° C. (determined by AASHTO (American Association of State Highway Transportation Officials)) and good cold cracking resistance at −34° C. Addition of polymer to asphalt increases the first number, i.e., provides higher temperature rut resistance, and improves fatigue resistance. Good low temperature properties are to a large extent dependent on the specific asphalt composition (e.g., flux oil content, penetration index), but the polymer type does influence low temperature performance. The asphalt industry considers polymers for asphalt modification to be either elastomers or plastomers. Generally, elastomeric polymers improve low temperature performance and plastomeric polymers decrease it. The word plastomer indicates a lack of elastomeric properties. Plastomers are sometimes used to modify asphalt because they can increase stiffness and viscosity, which improves rut resistance, but their performance is generally considered inferior to that of elastomers, due to lack of significant improvements in fatigue resistance, creep resistance, cold crack resistance, etc. Styrene/butadiene/styrene block copolymers (SBS) are considered elastomers. Also considered elastomers are ethylene/butyl acrylate/glycidyl methacrylate terpolymer (EnBAGMA) and ethylene/vinyl acetate/glycidyl methacrylate terpolymer (EEGMA), both available from E. I. du Pont de Nemours and Company of Wilmington, Del., USA (“DuPont”) under the trademark Elvaloy® RET. Polyethylene (PE) and ethylene vinyl acetate (EVA) resins are considered plastomers. PE is not miscible with asphalt, so asphalt comprising PE must be continuously stirred above the PE melting temperature to prevent separation. For this reason, asphalt modified with PE must be prepared at the mix plant and cannot be shipped at ambient temperatures. In most instances, these conditions are not met. Therefore, the PE acts as a filler and does not meaningfully increase the softening point of the asphalt.

The use of polymers as additives to asphalt (bitumen) is well known in the art. See for example U.S. Pat. Nos. 4,650,820 and 4,451,598, wherein terpolymers derived from ethylene, an alkyl acrylate and maleic anhydride are mixed with bitumen.

Also see for example U.S. Pat. Nos. 5,306,750; 6,117,926; and 6,743,838; and U.S. Patent Application Publication No. 2007/0027261, wherein reactant epoxy-functionalized, particularly glycidyl-containing, ethylene terpolymers are mixed and reacted with bitumen and, preferably (as taught in U.S. Pat. No. 6,117,926) with a catalyst to accelerate the rate of reaction and lower cost of the modified system. DuPont Elvaloy® RET reactive elastomeric terpolymers (e.g., EnBAGMA and EEGMA) are excellent modifiers for asphalt and improve asphalt performance at low concentrations (0.5 to 6.0 weight %, based on the total weight of the asphalt composition).

The improvement in asphalt properties with addition of Elvaloy® RET reactive elastomeric terpolymers at such low concentrations may be due to a chemical reaction between the Elvaloy® RET and the functionalized polar fraction of asphalt, sometimes referred to as “asphaltenes.” Superphosphoric acid (SPA) is sometimes added to the asphalt composition as a catalyst to increase the rate of this reaction. Addition of acid can be a negative in some cases, however. For example, some PMA producers believe that acid degrades properties or that acid is incompatible with amine based materials, such as the ones used as anti-stripping agents. Common anti-stripping agents include polyamines such as tetraethylenepentamine (TEPA) and bishexamethylenetriamine (BHMT); fatty amines; and amidoamines derived from fatty acids which in turn are derived from natural oils such as coconut oil and tall oil. The reaction between the Elvaloy® RET and the asphaltenes does occur with heat alone, although the rate is lower (about 6 to 24 hours without acid and about 3 to 6 hours with acid). In addition, asphalt modified with Elvaloy® RET in the absence of SPA is less elastic than asphalt modified with Elvaloy® RET in the presence of SPA, as evidenced by a higher phase angle and lower elastic recovery. Some PMA producers prefer acid catalysis and some prefer to use heat alone. Driving the modification reaction kinetics with heat alone does eliminate the problem with amine-based anti-strippping agents, however.

U.S. Pat. No. 5,331,028 describes blends of asphalt with a combination of glycidyl-containing ethylene copolymer and a styrene-conjugated diene block copolymer.

U.S. Pat. No. 6,087,420 describes a method for producing bitumen/polymer compositions comprising at least one styrene-butadiene copolymer.

U.S. Patent Application Publication No. 2012/0283365 discloses a mother solution free from oil of petroleum origin and a polymer used for preparing cross-linked bitumen/polymer compositions.

Mixing asphalt with elastomers such as EnBAGMA and EEGMA requires significant mechanical energy at elevated temperatures to achieve the benefits of their addition. Typically, the EnBAGMA and EEGMA are presented in pellet form and are added to hot asphalt. The pellets soften and melt due to the heat and the stirring. In order to decrease the time required to melt and disperse EnBAGMA or EEGMA into liquid asphalt, an improved method of preparing PMA compositions is desired.

### SUMMARY OF THE INVENTION

Provided herein is a composition comprising or produced from asphalt; an aromatic, paraffinic, vegetable or mineral oil or a liquid plasticizer; an epoxy-functionalized ethylene copolymer or terpolymer; and optionally one or more non-reactive polymers. The epoxy-functionalized ethylene copolymers and terpolymers comprise repeat units derived from ethylene and from an epoxy-containing comonomer. Preferred non-reactive polymers include poly-styrene-butadiene-styrene (SBS) copolymers and copolymers of ethylene with one or more alkyl (meth)acrylates.

Further provided is a method for preparing a polymer modified asphalt, the method comprising:

(1) dissolving an epoxy-functionalized ethylene copolymer or terpolymer and optionally a second polymer in an oil or in a liquid plasticizer to provide a polymer solution, wherein the oil is aromatic, paraffinic, vegetable, mineral or a combination of two or more of oils of these types; and

(2) heating and mixing the polymer solution with asphalt.

Optionally, the polymer-modified asphalt may further comprise or be produced from a sulfur source, an acid, or both an acid and a sulfur source. Accordingly, the acid or the sulfur source may be introduced into the asphalt composition in step (1) or in step (2), above.

### DETAILED DESCRIPTION OF THE INVENTION

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, the terms “a” and “an” include the concepts of “at least one” and “one or more than one”. The word(s) following the verb “is” can be a definition of the subject.

The term “consisting essentially of” in relation to compositions is to indicate that substantially (greater than 95 weight % or greater than 99 weight %) the only polymer(s) present in a composition is the polymer(s) recited. Thus this term does not exclude the presence of impurities or additives, e.g. conventional additives. Moreover, such additives may possibly be added via a masterbatch that may include other polymers as carriers, so that minor amounts (less than 5 or less than 1 weight %) of polymers other than those recited may be present. Any such minor amounts of these materials do not change the basic and novel characteristics of the composition.

When the term “about” is used in describing a value or an end-point of a range, the disclosure should be understood to include the specific value or end-point referred to.

Unless stated otherwise, all percentages, parts, ratios, etc., are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range starting from 0, such component is an optional component (i.e., it may or may not be present). When present an optional component may be at least 0.1 weight % of the composition or copolymer, unless specified at lower amounts.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that may have become recognized in the art as suitable for a similar purpose.

As used herein, the term “copolymer” refers to polymers comprising copolymerized units resulting from copolymerization of two or more comonomers and may be described with reference to its constituent comonomers or to the amounts of its constituent comonomers such as, for example “a copolymer comprising ethylene and 15 weight % of methyl acrylate”. A description of a copolymer with reference to its constituent comonomers or to the amounts of its constituent comonomers means that the copolymer contains copolymerized units (in the specified amounts when specified) of the specified comonomers. Polymers having more than two types of monomers, such as terpolymers, are also included within the term “copolymer” as used herein. A dipolymer consists essentially of two copolymerized comonomers and a terpolymer consists essentially of three copolymerized comonomers. The term “consisting essentially of” in reference to copolymerized comonomers allows for the presence of minor amounts (i.e. no more than 0.5 weight %) of non-recited copolymerized units, for example arising from impurities present in the commoner feedstock or from decomposition of comonomers during polymerization.

Further, the description following the verbs “is” or “are” can be a definition.

“(Meth)acrylate” includes methacrylate and/or acrylate. Alkyl (meth)acrylate refers to alkyl acrylate and/or alkyl methacrylate.

As used herein, “dissolve,” “dissolving” and related terms refer to a process in which solid particles such as pellets of polymer are mixed with liquid and over a brief period of time dissolves or disperses into the liquid phase, leaving no visible residue. Consistently, the term “solution”, as used herein, refers to free-flowing liquids with no solids visible to the human eye. The term “solution”, as used herein, does not include any characterization regarding the conformation of the polymer molecules, their possible entanglement, or their interaction with the oil or plasticizer molecules. Also consistently, the terms “dissolve” and “disperse” are synonymous and used interchangeably herein, when referring to the successful combination of a polymer with a liquid to form a liquid phase with no visible residue. The term “gel” as used herein refers to a viscous semisolid at room temperature. A gel may become free-flowing when heated, however.

In this connection, blends of high molecular weight polymers with other polymers, oils or liquid plasticizers can be characterized by their level of compatibility. The first category includes blends that are compatible in the purest sense, i.e., on a molecular level. The terms “miscible blend,” “miscibility,” and the like have been used for highly compatible polymer blends and are defined in Polymer-Polymer Miscibility, O. Olabisi, L. Robeson and M. Shaw, Academic Press (New York, 1979). In general, a highly compatible or miscible blend of a two-component system forms a homogeneous system with a single phase. In other words, the polymer of one component has some solubility in the other polymer, oil or plasticizer of the second component. This does not imply ideal molecular mixing but rather suggests that the level of molecular mixing is adequate to yield the macroscopic properties that are expected of a single-phase material. Because of the high molecular weights of polymeric materials, a truly homogeneous system, such as a mixture of water and ethanol, often cannot be achieved. Such highly compatible systems provide substantially clear or transparent blends, however, which are defined above as “solutions.”

Further in this connection, a second category of compatibility includes blends or dispersions that are not totally compatible on a molecular scale, but have sufficient molecular compatibility or molecular interaction to provide useful polymeric blend materials. Such an immiscible blend of a two-component system remains a two-phase system, and the two-phase nature can often be revealed using optical microcopy or electron microscopy. Because of the two-phase nature of an immiscible blend, the properties are often dictated by the major component. These blends usually are hazy, translucent or milky.

Finally, viscosity is a measure of the resistance of a fluid to being deformed by either shear or tensile stress. In everyday terms for fluids only, viscosity may be thought of as “thickness” or “internal friction”. For example, water is “thin”, having a lower viscosity, while honey is “thick”, having a higher viscosity. The less viscous a fluid is, the greater its ease of movement (fluidity). As used herein, viscosity refers to dynamic or absolute viscosity. For comparison, the viscosity of water at 25° C. is 0.894 centipoise, while the viscosity of chocolate syrup at the same temperature may range from about 10,000 to about 25,000 centipoise, depending on the magnitude of force that is applied and on its composition, for example the ratio of solids to water content.

It has now surprisingly been found that when a polymer solution made by dissolving epoxy-functionalized ethylene co-polymer or terpolymer in an oil or liquid plasticizer is added to asphalt, faster modification leads to decreased production time, and less equipment is required to carry out the modification. These factors in turn result in a significant cost reduction. Additional benefits from using the process have also been found.

Accordingly, provided herein is a polymer solution comprising an aromatic, paraffinic, vegetable or mineral oil or a liquid plasticizer; an epoxy-functionalized ethylene copolymer or terpolymer; and optionally one or more non-reactive polymers.

### Epoxy-Functionalized Ethylene Copolymer

Suitable epoxy-functionalized ethylene copolymers have a melt flow index as determined by ASTM D1238-65T, Condition E, of about 4 grams/10 minutes or less, preferably about 0.3 to about 4 grams/10 minutes, and more preferably about 0.3 to about 3 grams/10 minutes or to about 2 grams/10 minutes.

Preferably, the epoxy-functionalized ethylene copolymer is a glycidyl-containing polymer. Glycidyl-containing ethylene copolymers and modified copolymers useful in the invention are well known and can readily be produced by the concurrent reaction of monomers in accordance with U.S. Pat. No. 4,070,532, for example.

The glycidyl moiety may be represented by the following formula:

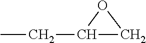

Generally useful glycidyl-containing, epoxy-functionalized ethylene copolymers will contain from about 0.3 (or about 0.5) to about 5 weight % or higher), based on the total weight of the epoxy-functionalized ethylene copolymer, of one or more comonomers containing glycidyl moieties.

The glycidyl-containing ethylene copolymer can comprise, consist essentially of, or consist of, repeat units derived from ethylene and from an epoxy comonomer including, for example, glycidyl esters of acrylic acid or methacrylic acid, glycidyl vinyl ether, or combinations thereof where the comonomer may be incorporated into the glycidyl-containing ethylene copolymer from about 0.3 to about 5 wt %, about 10 wt %, or about 17 wt %, based on the total weight of the epoxy-functionalized ethylene copolymer. The comonomer can include carbon monoxide, glycidyl acrylate, glycidyl methacrylate, glycidyl butyl acrylate, glycidyl vinyl ether, or combinations of two or more thereof.

Preferred epoxy-functionalized ethylene copolymers may be represented by the formula E/X/Y, where E is the copolymer unit —(CH₂CH₂)— derived from ethylene; X is the copolymer unit —(CH₂CR₁R₂)—, where R₁ is hydrogen, methyl, or ethyl, and R₂ is carboalkoxy, acyloxy, or alkoxy of 1 to 10 carbon atoms (X for example is derived from alkyl acrylates, alkyl methacrylates, vinyl esters, and alkyl vinyl ethers); and Y is the copolymer unit —(CH₂CR₃R₄)—, where R₃ is hydrogen or methyl and R₄ is carboglycidoxy or glycidoxy (Y for example is derived from glycidyl acrylate or glycidyl methacrylate). For purposes of this invention, the epoxy-containing comonomer unit Y may also be derived from vinyl ethers of 1 to 10 carbon atoms (e.g., glycidyl vinyl ether) or mono-epoxy substituted di-olefins having 4 to 12 carbon atoms. The R₄ in the above formula includes an internal glycidyl moiety associated with a cycloalkyl monoxide structure, e.g., Y may be derived from vinyl cyclohexane monoxide.

For this preferred embodiment, useful weight percentages of the E/X/Y copolymerized units preferably are 0 to about 40 (or when X is present, preferably about 20 to about 40 or about 25 to about 35) weight % of X; about 0.3 (or about 0.5) to about 3 (or about 4 or about 5) weight % of Y; and the remainder E, based on a total of 100 weight % of E, X, and Y copolymerized units in the epoxy-functionalized ethylene copolymer.

For example, one suitable epoxy-functionalized ethylene copolymer is an E/GMA dipolymer comprising repeat units derived from copolymerization of ethylene and glycidyl methacrylate (i.e., X is 0 weight % of the copolymer).

The epoxy-functionalized ethylene copolymer may optionally include repeat units derived from an ester of unsaturated carboxylic acid such as (meth)acrylate or C₁ to C₈ alkyl (meth)acrylate, or combinations of two or more thereof (an E/X/Y terpolymer as described above). Preferred (meth)acrylates include iso-butyl acrylate, n-butyl acrylate, iso-octyl acrylate, methyl acrylate or methyl methacrylate. Also preferably, Y is selected from glycidyl acrylate or glycidyl methacrylate. Notable E/X/Y terpolymers comprise copolymerized units of ethylene, n-butyl acrylate and glycidyl methacrylate (an EnBAGMA copolymer) or copolymerized units of ethylene, methyl acrylate and glycidyl methacrylate (an EMAGMA copolymer).

In addition, the epoxy-functionalized ethylene copolymer may optionally include repeat units derived from a C₂ to C₈ carboxylic acid ester of an unsaturated alcohol such as vinyl alcohol (an E/X/Y terpolymer as described above), wherein the vinyl ester is X. A particularly useful vinyl ester is vinyl acetate. A notable E/X/Y terpolymer comprises copolymerized units of ethylene, vinyl acetate and glycidyl methacrylate (an EVAGMA copolymer).

It is also preferred that the epoxy-containing monomers be incorporated into the epoxy-functionalized ethylene copolymer by the concurrent reaction of monomers (direct polymerization) and not by grafting onto the reactant polymer by graft polymerization.

Another suitable epoxy-functionalized ethylene copolymer has a melt flow index as determined by ASTM D1238-65T, Condition E, of about 4 grams/10 minutes of less, preferably about 0.3 to about 4 grams/10 minutes, and more preferably about 0.3 to about 3 grams/10 minutes or to about 2 grams/10 minutes.

### Oils and Plasticizers

The polymer solution also comprises at least one liquid plasticizer. A liquid plasticizer is an additive that increases the plasticity or fluidity of a material. The major applications are for plastics. For example, phthalate esters improve the flexibility and durability of polymer compositions. Additional examples of suitable liquid plasticizers are carboxylate esters including, but not limited to, dicarboxylic or tricarboxylic ester-based plasticizers, such as bis(2-ethylhexyl) phthalate (DEHP), di-octyl phthalate (DOP), diisononyl phthalate (DINP), and diisodecyl phthalate (DIDP). Liquid plasticizers also include acetic acid esters of monoglycerides made from castor oil; and other nonphthalate plasticizers suitable for use with PVC, including trimellitates, such as tris(2-ethylhexyl) trimellitate; adipates, such as bis(2-ethylhexyl) adipate; benzoates, such as 1,5-pentanediol dibenzoate; adipic acid polyesters; polyetheresters; epoxy esters; and maleates.

Alternatively, the plasticizer may be a flux oil. Flux oils encompass many types of oils used to modify asphalt and are the final products in crude oil distillation. They are non-volatile oils that are blended with asphalt as softeners. The oils may be aromatic, such as Paulsboro's ValAro™ paraffinic, such as HollyFrontier's Hydrolene™ or mineral, such as Sonnerborn's Hydrobryite™. Flux oils also encompass any renewably-produced vegetable or bio-oil, such as for example corn oil and shortening, i.e., hydrogenated or partially hydrogenated vegetable oil.

The polymer solution comprises about 1 to about 99, or about 10 to about 80, or about 20 to about 70, or about 25 to about 60 wt % of the one or more epoxy-containing ethylene copolymers and about 99 to about 1, or about 90 to about 20, or about 80 to about 30, or about 75 to about 40 wt % of the one or more flux oils or liquid plasticizers, based on the total weight of the polymer solution.

### Non-Reactive Polymers

The polymer solution may optionally further comprise one or more additional polymers. Suitable additional polymers include those that do not react with asphalt or with epoxy-functionalized ethylene copolymers. Preferred non-reactive polymers are known in the art for inclusion in polymer-modified asphalt and are known not to react with the asphalt. For this reason, they are sometimes referred to as “diluent” polymers. More specifically, preferred non-reactive polymers include styrene/conjugated-diene block copolymers, such as poly-styrene-butadiene-styrene (SBS) copolymers, and copolymers of ethylene with one or more alkyl (meth)acrylates.

Suitable styrene/conjugated-diene block copolymers are well known polymers derived from, or comprising copolymerized units of, styrene and a conjugated diene, such as butadiene, isoprene, ethylene butene, 1,3-pentadiene, or the like. Nevertheless, the term “styrene-butadiene-styrene” block copolymer, or “SBS” copolymer, unless otherwise specified under limited circumstances, is used herein to refer to any block copolymer of styrene and a conjugated diene.

The styrene/conjugated-diene block copolymers may be di-, tri- or poly-block copolymers having a linear or radial (star or branched) structure, with or without a random junction. Suitable block copolymers include, for example, diblock A-B type copolymers; linear (triblock) A-B-A type copolymers; and radial (A-B)ₙ type copolymers; wherein A refers to a copolymer unit derived from styrene and B refers to a copolymer unit derived from a conjugated diene. Preferred block copolymers have a linear (triblock) A-B-A type structure or a radial (A-B)ₙ type structure. SIS and SEBS block copolymers are also preferred.

Generally, the styrene/conjugated diene block copolymer will contain about 10 to about 50 weight % of copolymer units derived from styrene and complementarily about 50 to about 90 weight % of copolymer units derived from a conjugated diene, preferably butadiene or isoprene, more preferably butadiene. More preferably, 20 to 40 weight % of the copolymer units will be derived from styrene, the remainder being derived complementarily from the conjugated diene. As used herein, the term “complementarily” refers to a set of values having a sum of unity, such as, for example, the sum of the weight percentages of the components in a composition.

Preferably, the styrene/conjugated-diene block copolymers have a weight-average molecular weight from a lower limit of about 10,000; 30,000; 100,000; 150,000 or 200,000 daltons to a higher limit of about 500,000; 600,000; 750, 000 or 1,000,000 daltons. The weight-average molecular weight of the styrene/conjugated-diene block copolymer can be determined using conventional gel permeation chromatography. The weight-average molecular mass of the copolymer of styrene and of butadiene is between 10,000 and 600,000 daltons, preferably between 30,000 and 400,000 daltons.

The melt flow index of the styrene/conjugated-diene block copolymer is typically in the range of from about 0 to about 200 g/10 min, preferably about 0 to 100 g/10 min, more preferably about 0 to 10 g/10 min, as determined by ASTM Test Method D 1238, Condition G.

The copolymers of styrene and conjugated-diene can be prepared by anionic polymerization of the monomers in the presence of initiators composed of organometallic compounds of alkali metals, in particular organolithium compounds, such as alkyllithium and in particular butyllithium, the preparation being carried out at temperatures of less than or equal to 0° C. and in solution in a solvent that is at least partly composed of a polar solvent, such as tetrahydrofuran or diethyl ether. Preparation procedures include those described in U.S. Pat. Nos. 3,281,383 and 3,639,521.

Typical SBS polymers include Kraton's Kraton D0243 (with 31 To 35% of polystyrene, 75% diblock content, and 20 grams/10 minutes of MI) and/or linear structure as Dynasol's Calprene 501 or LG 501 (31% polystyrene, <=1 grams/10 minutes MI) and/or radial structure as Dynasol's Solprene 411 or LG—411 (31% polystyrene, <=1 gram/10 minutes MI). (Kraton's headquarters and Dynasol's offices are in Houston, Tex., Dynasol's website: http://www.dynasolelastomers.com/ and Kraton's: http://www.kraton.com/).

Preferred non-reactive polymers also include copolymers of ethylene with one or more alkyl (meth) acrylates, such as for example ethylene acrylate copolymers, ethylene methacrylate copolymers and ethylene vinyl acetate copolymers; ethylene butene block copolymers; and polyolefins produced by any process known in the art with any known transition metal catalysts. Also preferred are olefinic polymers, such as polyethylene, polypropylene, polybutene, and polyisobutene; ethylene/propylene copolymers; ethylene/propylene/diene terpolymers; and homopolymers such as polybutadiene, polyisoprene or polynorbornene.

When present in the polymer solution, the non-reactive polymer is present in an amount of about 10 to about 30 wt %, based on the total weight of the polymer solution. Preferably, the non-reactive polymer is present in an amount of about 15 to about 30 wt %, and more preferably about 20 to about 25 wt %.

### Asphalts and Bitumens

Further provided herein is an asphalt composition comprising the polymer solution, one or more asphalts or bitumens, and optionally an acid or a sulfur source. Asphalt or bitumen can be obtained as a residue in the distillation or refining of petroleum or can be naturally occurring, as is the case with Salamanca asphalt. All types of asphalts and bitumens are useful in this invention, whether natural or synthetic. Representative sources for asphalts include, without limitation, native rock, lake asphalts, petroleum asphalts, airblown asphalts, and cracked or residual asphalts.

Chemically, asphalt is a complex mixture of hydrocarbons that can be separated into two major fractions, asphaltenes and maltenes. The asphaltenes are polycyclic aromatics and most contain polar functionality. Some or all of the following functionalities are present: carboxylic acids, amines, sulfides, sulfoxides, sulfones, sulfonic acids, porphyrin rings or other aromatic or semi-aromatic ring systems metallated with cations such as vanadium, nickel or iron cations, for example. The maltene phase contains some or all of: polar aromatics, aromatics, and naphthene. It is generally believed that asphalt is a colloidal dispersion in which the asphaltenes are dispersed in the maltenes and the polar aromatics act as the dispersing agent. The asphaltenes are relatively high in molecular weight (about 1500 Da) as compared with the other components of the asphalt. The asphaltenes are amphoteric in nature and are believed to self-associate, forming clusters that offer some viscoelastic behavior to asphalt. Asphaltenes vary in functionality and the content of asphaltenes varies depending on the crude source from which the asphalt is derived.

All asphalts and bitumens containing asphaltenes are suitable for use in the composition. The asphalt can be of low or high asphaltene content.

The asphaltene content can be from about 0.01 to about 30, about 0.1 to about 15, about 1 to about 10, or about 1 to about 5% by weight, based on the total weight of the asphalt or bitumen. “High asphaltene asphalts” typically contain more than 7 weight % of asphaltenes or more than 10 weight % of asphaltenes. Generally, suitable asphalts and bitumens contain less than 5 weight % of oxygen compounds and frequently less than 1 weight % of oxygen compounds, again based on the total weight of the asphalt or bitumen. Examples of suitable asphalts and bitumens include, without limitation, Wyoming Sour, Mayan, Venezuelan, Canadian, Arabian, Trinidad Lake, Salamanca and combinations of two or more of these materials.

Preferred asphalts have a viscosity at 60° C. of 100 to 20,000 poise, preferably 200 to 10,000, more preferably 300 to 4000, and still more preferably 400 to 1500 poise.

Modified asphalts are also suitable. For example, a sulfonated asphalt or salt thereof (e.g., sodium salt), an oxidized asphalt, or a combination of two or more modified asphalts, or a combination of one or more modified asphalts with one or more natural asphalts may be used in the composition.

### Sulfur Source or Acid

The asphalt composition may further optionally include a sulfur source, such as elemental sulfur, a sulfur donor, a sulfur byproduct, and combinations of two or more thereof. A sulfur donor generates sulfur in situ when included in the composition. Examples of sulfur donors include sodium diethyldithiocarbamate; 2,2-dithiobis(benzothiazole); mercaptobenzothiazole; dipentamethylenethiuram tetrasulfide; and combinations of two or more thereof. Also included is Sasobit™ TXS (available from Sasol Wax Americas, Shelton, Calif., USA). A sulfur byproduct can include one or more sulfonic acids, sulfides, sulfoxides, sulfones, or combinations of two or more thereof. Typical content of the sulfur source as an additive in the asphalt composition ranges from 10 ppm to 5,000 ppm, by weight, based on the total weight of the asphalt composition.

The solution may further optionally include an acid. Suitable acids include inorganic acids and organic acids, such as mineral acids, sulfonic acids, carboxylic acids, and combinations of two or more thereof. Examples of preferred acids include, without limitation, polyphosphoric acid (PPA) and superphosphoric acid.

Without wishing to be held to theory, it is believed that the acid and the sulfur source act as catalysts to promote the modification reaction between the epoxy-functionalized ethylene copolymer and the asphalt.

The asphalt composition comprises or is produced from about 0.01 to about 10 weight %, or about 0.1 to about 8 weight %, or about 0.5 to about 5 weight % of the polymer solution, based on the total weight of the asphalt composition; and about 0.001 to about 5 weight %, or about 0.005 to about 2 weight %, or about 0.01 to about 0.5 weight % of sulfur source, also based on the total weight of the asphalt composition.

The acid may be added to the asphalt composition in the amount of about 0.001 to about 10, or about 0.01 to about 5, or about 0.05 to about 3, or about 0.1 to about 2, or about 0.1 to about 0.3 weight %, based on the total weight of the asphalt composition. Without wishing to be held to theory, it is believed that some acids, such as PPA, are consumed by reacting to form both ionic and covalent bonds. Accordingly, the free acid or its conjugate based may not be detectable in the modified asphalt composition.

The non-reactive polymers can be combined into the reactive asphalt, epoxy-functionalized ethylene copolymers so they comprise 0 to 18 weight % of the asphalt composition, or 0 to 15 weight %, or 0 to 10 weight %, or 0 to 5 weight %. When present, they may be included from a lower limit of 0.1 or 1 to an upper limit of 5, 10, 15, or 18 weight % of the composition.

Complementarily, the remainder of the asphalt composition comprises or is produced from asphalt. Stated alternatively, the sum of the weight percentages of the components of the asphalt composition is 100 wt %.

### Methods

The polymer solution is added to the asphalt or bitumen to form the asphalt composition. The sulfur source or the acid can be added to the asphalt composition in the same step or in steps that are separate from the step of adding the polymer solution to the asphalt. For example, the polymer solution can be added to the asphalt, mixed for a brief period of time, and then the acid can be added with further mixing to this sub-combination of components of the final asphalt composition.

Polymer-modified asphalts (PMAs) have been typically produced in a high-shear mill process, or in a low-shear mixing process, as is well known to one skilled in the art. For example, the process is dependent on the equipment available, and on the asphalt and polymers used. Polymers that can be used in low-shear mixing equipment can be used in high-shear equipment also. A molten mixture of asphalt and polymer modifiers can be heated at about 160 to about 250° C., or about 170 to 225° C. under a pressure that can accommodate the temperature range, such as atmospheric pressure, for about 1 to about 35 hours, or about 2 to about 30 hours, or about 5 to about 25 hours. The acid or sulfur based catalyst may be added to facilitate reaction between the asphalt and the modifier. The molten mixture can be mixed by, for example, a mechanical agitator or any other suitable mixing means.

Publications IS-200, from the Asphalt Institute of Lexington, Ky., are among the references that describe suitable methods for the commercial production of PMAs.

An example of a conventional process for blending elastomeric polymers such as EnBAGMA with asphalt includes:
1) heating the base bitumen or asphalt to 180 to 190° C., either prior to or after addition to a reaction vessel, such as a tank;
2) adding the polymer to the heated asphalt in the tank with stirring for about 3 to 4 hours including the addition and the reaction time, while maintaining the temperature of the combination at 180 to 190° C.; and
3) adding a catalyst, such as polyphosphoric acid (PPA), to the combination in about 15 minutes, and mixing for about one additional hour.

When an acid catalyst is not used, the mixing of the asphalt and the polymer may require extended mixing times, for example greater than six hours, to provide complete reaction.

Use of a flux oil or a liquid plasticizer as described herein provides an improved process for mixing polymer modifiers with asphalt. The composition can be produced by, for example:
(1) dissolving an epoxy-functionalized ethylene copolymer, and optionally a non-reactive polymer, a sulfur source, or combinations of two or more thereof in the flux oil or liquid plasticizer to provide a solution; and
(2) mixing the epoxy-functionalized ethylene copolymer solution with asphalt.

The first epoxy-functionalized ethylene copolymer and the optional non-reactive polymer and/or sulfur source in any physical form, such as pellets, can be mixed in a mixer by dry blending or by the conventional masterbatch technique, or the like. The combinations can be subject to a condition including heating to a range of about 120 to about 250° C., or about 140 to 225° C., or to molten stage in any suitable vessel such as a mixing tank or a reactor or a metal can to provide a melt blended composition. An epoxy-containing ethylene copolymer can be combined with, or added to, a flux oil or a plasticizer as described above by any means known to one skilled in the art to produce a solution. The polymer modifier(s) and other optional components can be dissolved in the flux oil or liquid plasticizer by mixing with the oil or plasticizer. To facilitate the formation of a solution, the combination or addition can be mixed by mechanical means such as stirring. For example, the formation of a polymer solution in oil or plasticizer can be carried out under atmospheric condition, stirring for 10 to 30 minutes at 120 to 150° C. and 700 to 800 RPM. The resulting blend, a solution of polymer modifier in oil or plasticizer, has the consistency of free-flowing oil at elevated temperatures.

After its preparation, the epoxy-functionalized ethylene copolymer solution can be mixed with asphalt. The base asphalt can be preheated to 150 to 180° C. or higher in a blending vessel to make it flowable. The ethylene copolymer solution can be added with stirring at temperatures from 150 to 190° C., such as about 185 to 190° C. It is desirable to heat the materials to as low a temperature as necessary while still obtaining good processing rates. Dispersion of the ethylene copolymer solution into the asphalt may take 10 to 30 minutes. If desired, a catalyst such as PPA can be added following the dispersion of the ethylene copolymer solution and the mixture blended for an additional period of time, such as about 15 to about 45 minutes. Without using an acid catalyst, mixing may take up to about 10 to 12 hours to complete.

Alternatively the polymer solution can be added as a solid, e.g., when the polymer solution is a solid at room temperature, to asphalt that is stirred in a blending tank at 150 to 190° C. or 185 to 190° C.

The polymer solution may also be prepared by an extrusion method. This method is preferred when the polymer solution is a solid at room temperature. One preferred extrusion method includes the step of compounding 10 to 50% by weight of a suitable flux oil or plasticizer with 50 to 90% by weight of the epoxy-functionalized ethylene copolymer using a high intensity mixer such as a twin screw extruder. Another preferred twin screw extrusion process includes the following steps:
a. Adding an epoxy-functionalized ethylene copolymer or ter-polymer to an extruder;
b. Homogeneously melting the polymer in a melting zone of the extruder, forming a melt seal zone of the extruder;
c. Adding an oil or liquid plasticizer under pressure to the molten polymer in an injection zone, wherein the injection zone is located following the melt seal zone of the extruder and before the mixing zone;
d. Providing a mixing zone with first distributive and then dispersive mixing elements to ensure phase inversion of the low viscosity liquid into the higher viscosity polymer;
e. Providing a secondary melt seal ahead of the vacuum extraction zone;
f. Providing a melt extraction zone under vacuum controlled with a nitrogen sweep;
g. Providing a melt pumping zone to enable pressurization ahead to the die-head and pelletization;
h. Pelletizing by underwater melt cutting or by strand cutting;
i. Optionally, providing a melt pump that precedes an underwater melt cutting system.

In preferred extrusion processes, the pressure in area of the extruder around the liquid injection zone is sufficiently high to ensure that the injected liquid remains liquid for a sufficient amount of time for it to be completely compounded into the polymer.

During the injection and subsequent mixing steps, it is particularly preferred that the extruder be completely full and that there be no free volume that would allow pooling or flashing of the injected liquid.

Ideally, the initial melt seal zone is maintained at a pressure higher than the highest vapor pressure of the liquid being injected so that no vapors are formed that could travel against the direction of polymer flow. As a result, the secondary melt seal is maintained at a high enough pressure so that the injected oil or plasticizer does not vaporize and escape into the vacuum extraction zone.

The secondary melt seal and pressurization may optionally be a part of the melt compounding zone located subsequent to the melt injection zone, provided that sufficient back pressure is generated to avoid the flashing and venting of the oil or liquid plasticizer being compounded into the polymer.

Finally, processing conditions such as extruder feed rate, extruder screw speed and temperature profile can be used to manage the process for a suitably designed screw configuration. Additionally, it is preferred to use loss-in-weight methods to control both the polymer addition as well as the liquid injection to ensure uniform composition and to prevent surging due to inconsistent feeds. Surging can interfere with maintaining sufficient melt seals or pressure build-up zones. Additionally, it is preferred to use a heated injection system to better match the injection temperature of the liquid with the polymer melt temperature. The safe and efficient management of these and other factors is well within the ordinary skill of the art.

The asphalt composition can also be used as a roofing or waterproofing product. For example, asphalt compositions may be used as an adhesive to adhere various roofing sheets to roofs, or they may be used as a waterproofing covering for many roofing fabrics. Asphalt compositions can also be used as chip seals, as emulsions, in other roofing products, and as repair products, for example to seal or patch paved surfaces.

The asphalt composition described herein can be used to make an elastomerically modified asphalt. For example, the asphalt composition can be mixed with aggregates in an amount of about 1 to about 10 or about 5 wt % of the asphalt composition, and about 90 to about 99 or about 95 wt % aggregates, based on the total weight of the asphalt composition and the aggregates, and used as a polymer-modified asphalt mixture for paving. The polymer-modified asphalt mixtures may also include other additives, of the types and in the amounts that are conventional for the intended end-use. See, for example, “Asphalt” in the Kirk-Othmer Encyclopedia of Chemical Technology, John Wiley & Sons, Inc. published online December, 2000. Polymer-modified asphalt mixtures can be used for paving of highways, city streets, parking lots, ports, airfields, sidewalks, and other surfaces. They also find use in repair products for paved surfaces, in roofing applications, and in any other application in which an elastomerically-modified asphalt is typically used.

The following examples are provided to describe the invention in further detail. These examples, which set forth specific embodiments and a preferred mode presently contemplated for carrying out the invention, are intended to illustrate and not to limit the invention.

### EXAMPLES

### Materials

EnBAGMA-1: a terpolymer comprising 70 weight % of copolymerized units of ethylene, 21 weight % of copolymerized units of n-butyl acrylate and 9 weight % of copolymerized units of glycidyl methacrylate, with density of 0.94 g/cc, melting point of 72° C., and melt index of 8 g/10 min by ASTM D1238-65T.
EEGMA-1: a terpolymer comprising 76 weight % of copolymerized units of ethylene, 15 weight % of copolymerized units of vinyl acetate and 9 weight % of copolymerized units of glycidyl methacrylate, with density of 0.96 g/cc, melting point of 82° C., and melt index of 8 g/10 min by ASTM D1238-65T.
ValAro™ 100: a naphthenic oil obtained from the Paulsboro Refining Company of Paulsboro, N.J.
Hydrolene™ 90T: a heavy paraffinic distillate solvent extract with high aromatic content,
Hydrolene™ LPH: a heavy paraffinic distillate solvent extract with low polycyclic aromatic hydrocarbon content from Holly Frontier Refining & Marketing LLC—from Tulsa, Okla.
Hydrolene™ H50T: Holly Frontier Refining & Marketing LLC
Hydrolene™ H125T: Holly Frontier Refining & Marketing LLC
Hydrolene™ H180TN: Holly Frontier Refining & Marketing LLC
Hydrolene™ H600T: Holly Frontier Refining & Marketing LLC
Emery™ 2932: Emery Oleochemicals—Cincinnati Ohio.
Sylfat™ DP9/FA-1: Arizona Chemical—Atlanta Ga.
Century™D-1: Arizona Chemical—Atlanta Ga.
Hydrobright™380PO: Sonneborn LLC—Parsipanny N.J. Hydrogenated fat or shortening mainly composed of different sources of unsaturated vegetable oils that have been hydrogenated by the hydrogenation process for oils, available from US's Crisco or Mexico's Inca. Inca™—ACH Foods Mexico, S de RL de CV—Mexico City, MEX Crisco™—The JM Smucker Company—Orrville, Ohio.
DOP: dioctyl phthalate, commercially available from Mexichem Compuestos, SA.—Mexico City, MEX
DIDP: diisodecyl phthalate, commercially available from EIQSA (Especialidades Industriales y Quimicas, SA de CV)—Mexico City, MEX
DINP: diisononyl phthalate, commercially available from Mexichem Compuestos, SA
   Dissolving Epoxy-Functionalized Ethylene Copolymer in Flux Oil and/or Liquid Plasticizer

Epoxy-functionalized ethylene copolymer solutions were prepared as summarized in Table 1.

The epoxy-functionalized ethylene copolymer was dissolved in flux oil and/or plasticizer according to the following General Procedure. A custom-designed and fabricated mixing apparatus was equipped with a 2-liter stainless steel container; a conventional hot plate for heating the oil or plasticizer; and a stirrer comprising a motor having a rotational speed of about 750 to 800 rpm and a propeller having a shaft for removably engaging with the motor and having three blades, each 5 cm long, for blending. The propeller blades were positioned as close to the bottom of the container as possible to provide thorough mixing.

The flux oil or plasticizer in the container was preheated to 120° C. (248° F.). Pellets of the epoxy-functionalized ethylene copolymer were added to the preheated oil or plasticizer and the combination was immediately mixed for 30 to 45 minutes at a propeller speed of 750 to 800 RPM. The resulting clear solution had a consistency of thick oil at 70 to 80° C. and a consistency of a thick gel at room temperature (20 to 25° C.). The compositions of the solutions so prepared are summarized in Table 1.

TABLE 1

| | |
|---|---|
| Oil or Plasticizer | Ethylene Copolymer |

| Solution | type | % | | % |
|---|---|---|---|---|
| A | ValAro 100 | 60 | EEGMA-1 | 40 |
| B | ValAro 100 | 70 | EEGMA-1 | 30 |
| C | DINP | 60 | EEGMA-1 | 40 |
| D | Hydrolene ™ 90T | 60 | EEGMA-1 | 40 |
| E | Hydrolene ™ 90T | 60 | EnBAGMA-1 | 40 |
| F | Hydrolene ™ 90T | 50 | EEGMA-1 | 50 |
| G | Hydrolene ™ 90T | 50 | EnBAGMA-1 | 50 |

All polymer modified asphalt (PMA) blends were prepared in a 1000-ml metal can. The total weight of each blend was 800 g. The polymers were added to the asphalt (percentage was based on the total weight of the blend) as shown in the Tables. The asphalt was heated to 180° C. and the polymer solution was added as a thick gel or heated to about 120 to 140° C. to provide a liquid consistency. Mixing was done at “turbulent” stage, with a Reynolds number (Re) above 10,000. The incorporation of the polymer solution into the heated asphalt took about 10 to 15 minutes. After this time, polyphosphoric acid (PPA, 13 wt % based on the weight of the epoxy-functionalized ethylene copolymer) was added in one aliquot. The change in viscosity that was observed qualitatively within about 15 minutes of PPA addition showed that modification of the asphalt by the plasticizer blend had occurred. Before addition of the PPA, the asphalts mixed with the plasticizer blends showed qualitative evidence of elastic recovery.

For comparison, a blend of EnBAGMA-1 in asphalt without previous dispersion in oil or liquid plasticizer required stirring with a three paddle stirrer at 300 rpm for 1 hour at 185° C. before addition of the aliquot of PPA, followed by 3 additional hours of stirring at about 400° F. (about 200° C.) and atmospheric pressure. Several experiments were run using PEMEX EKBÉ (Salamanca 64-22) asphalt as a base. The compositions are set forth in Tables 2 and 3, in which the percentages are weight percentages based on the total weight of the asphalt composition, and in which the amount of base is complementary to the amounts of additives specified.

TABLE 2
Control Samples

| Additive | | | | |
|---|---|---|---|---|
| (%) | | Polymer | Oil | PPA |
| Control 0 | neat base | (0) | (0) | (0) |
| Control 1 | | EnBAGMA-1 (1) | (0) | (0.16) |
| Control 2 | | EEGMA-1 (1) | (0) | (0.16) |
| Control 3 | | EEGMA-1 (1) | ValAro 100 (1.5) | (0.16) |
| Control 4 | | EEGMA-1 (1) | Hydrolene 90T (1) | (0.16) |

Controls 1 and 2 were prepared according to the General Procedure, above. Controls 3 and 4 were prepared according to the standard practice of adding the polymer and the oil to the asphalt without first forming a solution.

Unless otherwise mentioned, the process modification trials were conducted by heating the asphalt to 185° C. to 190° C. and stirring at 300 RPM, adding the ethylene copolymer solutions heated at 140° C., mixing for 10 to 15 minutes at 500 to 750 RPM, and then adding the PPA in one aliquot to the blend and stirring for another 15, 30 or 60 minutes. After each time point, samples were taken and analyzed as described below. Mixing a preformed solution of ethylene copolymer in the oil or plasticizer resulted in a much more rapid formation of a reacted blend compared to mixing the components without preforming a solution.

TABLE 3
Process Examples

| | | | Additive (%) | | |
|---|---|---|---|---|---|
| Example No. | Solution | (%) | Polymer | Oil or Plasticizer | PPA |
| 1 | A | 2.50 | EEGMA-1 (1) | ValAro 100 (1.5) | 0.16 |
| 2 | D | 2.50 | EEGMA-1 (1) | Hydrolene ™ 90T (1.5) | 0.16 |
| 3 | F | 2.00 | EEGMA-1 (1) | Hydrolene ™ 90T (1) | 0.16 |
| 4 | G | 2.00 | EnBAGMA-1 (1) | Hydrolene ™ 90T (1) | 0.16 |
| 5 | B | 3.33 | EEGMA-1 (1) | ValAro 100 (2.33) | 0.16 |
| 6 | C | 2.50 | EEGMA-1 (1) | DINP (1.5) | 0.16 |
| 7 | E | 2.50 | EnBAGMA-1 (1) | Hydrolene ™ 90T (1.5) | 0.16 |
| 8 | E | 2.75 | EnBAGMA-1 (1.1) | Hydrolene ™ 90T (1.65) | 0.16 |
| 9 | E | 3.25 | EnBAGMA-1 (1.3) | Hydrolene ™ 90T (1.95) | 0.16 |
| 10 | F | 2.20 | EEGMA-1 (1.1) | Hydrolene ™ 90T (1.1) | 0.16 |
| 11 | C | 2.75 | EEGMA-1 (1.1) | DINP (1.65) | 0.16 |
| 12 | F | 2.60 | EEGMA-1 (1.3) | Hydrolene ™ 90T (1.3) | 0.16 |
| 13 | C | 3.25 | EEGMA-1 (1.3) | DINP (1.95) | 0.16 |
| 14 | E | 2.50 | EnBAGMA-1 (1) | Hydrolene ™ 90T (1.5) | 0.16 |
| 15 | C | 2.50 | EEGMA-1 (1) | DINP (1.5) | 0.16 |
| 16 | G | 2.00 | EnBAGMA-1 (1) | Hydrolene ™ 90T (1) | 0.16 |

Dynamic Shear Rheometer Failure temperature and phase angle were measured. The results are reported in Tables 4 through 8.

In addition, the rheological properties of the asphalt binders (PMAs) were determined using a Dynamic Shear Rheometer (DSR) according to the ASSHTO T 315 or ASTM D7175-08 methods.

The Dynamic Shear Rheometer (DSR, model Kinexus Pro+from Malvern Instruments, Westborough, Mass.) is used to characterize the viscous and elastic behavior of asphalt binders at medium to high temperatures. This characterization is used in the Superpave PG asphalt binder specification. Superpave is the result of the Strategic Highway Research Program (SHRP) from the FHWA (www.fhwa.dot.gov), and is a specification from the AASHTO (American Association of Highway and Transportation). See also http://www.transportation.org/Pages/Organization.aspx.

As with other Superpave binder tests, the asphalt binders are tested at temperatures that are typical of the climates of the geographical regions in which the asphalts will be used.

The DSR test method is used to determine the dynamic (oscillatory) shear modulus and phase angle of asphalt binders using parallel plate geometry and may also determine the linear viscoelastic properties of asphalt binders as required for specification testing.

Again, the Pass/Fail temperatures are related to the climate in the geographical area where the asphalt binder is to be used. The Pass temperature is determined by a Superpave classification scale that assigns an asphalt performance grade (PG) at a series of temperatures at intervals of 6° C., for example, 52, 58, 64, 70, 76, 82 or 88° C., and the Fail temperature is the actual value at which the modified asphalt fails.

The complex shear modulus is an indicator of the stiffness of the asphalt binder, or its resistance to deformation under load. The complex shear modulus and the phase angle define the resistance to shear deformation of the asphalt binder in the linear viscoelastic region. The dynamic modulus and phase angle may depend upon the magnitude of the shear strain. The modulus and phase angle for both unmodified and modified asphalt cement decrease with increasing shear strain.

The controls whose properties are listed in Table 4 were prepared by mixing the ethylene copolymer and the oil or plasticizer with asphalt without first preparing a solution and mixing for 1 hour prior to adding PPA, or they were prepared according to the procedures described above with respect to Table 2.

TABLE 4

| | Mixing time with PPA | Pass | Fail | Phase angle |
|---|---|---|---|---|
| Example | (minutes) | (° C.) | (° C.) | (°) |
| Control 0 | (neat base) | 70 | 73.2 | 87.16 |
| Control 1 | 60 | 88 | 88.8 | 68.49 |
| Control 2 | 60 | 88 | 91.8 | 68.43 |
| Control 3 | 60 | 88 | 90.7 | 69.2 |
| Control 4 | 60 | 88 | 91.9 | 69.14 |

Experimental results for the Examples whose compositions are described in Table 3 are set forth in Tables 5, 6 and 7. Examples 1 through 7 include 1 wt % of EEGMA-1 or EnBGMA-1 that was added to the heated asphalt in a polymer solution heated to 140° C. First, the results show that the DSR failure temperature and phase angle for blends prepared by preforming a solution were essentially the same for blends prepared using paraffinic oil, although the mixing times may differ. See, e.g., Example 3 compared to Control 4.

TABLE 5

| | Mixing time with PPA | Pass | Fail | Phase angle |
|---|---|---|---|---|
| Example | (minutes) | (° C.) | (° C.) | (°) |
| 1 | 15 | 82 | 84.6 | 73.48 |
| | 30 | 82 | 85.5 | 72.43 |
| 3 | 0 | 76 | 78.2 | 84.56 |
| | 15 | 88 | 90.2 | 69.21 |
| | 30 | 88 | 91.2 | 69.26 |
| 4 | 0 | 76 | 77.1 | 85.43 |
| | 15 | 82 | 87.2 | 71.52 |
| | 30 | 88 | 90.8 | 71.02 |
| 5 | 0 | 70 | 74.6 | 84.12 |
| | 15 | 82 | 85.8 | 69.87 |
| | 30 | 82 | | 69.06 |
| 6 | 0 | 70 | 74.9 | 84.51 |
| | 15 | 82 | 85.7 | 70.87 |
| | 30 | 82 | 86.2 | 70.12 |
| 7 | 0 | 70 | 75.9 | 84.51 |
| | 15 | 82 | 86.7 | 72.03 |
| | 30 | 82 | 87.5 | 71.49 |

| | |
|---|---|
| 2 | Overheated and gelled |

Examples 8 through 13, reported in Table 6, include more than 1 wt % of EEGMA-1 or EnBGMA-1 that was added to the heated asphalt in a polymer solution heated to 140° C. These Examples demonstrate that some PMAs with higher amounts of polymer modifier exhibited higher DSR failure temperatures and lower phase angles than the corresponding PMAs with 1 weight % of polymer modifier, such as Example 9 compared to Examples 8 and 4.

TABLE 6

| | Mixing time with PPA | Pass | Fail | Phase angle |
|---|---|---|---|---|
| Example | (minutes) | (° C.) | (° C.) | (°) |
| 8 | 0 | 76 | 77 | 85.11 |
| | 15 | 88 | 88.4 | 72.03 |
| | 30 | 88 | 89.2 | 71.49 |
| 9 | 0 | 76 | 81.6 | 79.32 |
| | 15 | 88 | 92.5 | 69.09 |
| | 30 | 94 | 94.6 | 66.43 |
| | 60 | 88 | 93 | 66.6 |
| 10 | 0 | 76 | 79.7 | 83.91 |
| | 15 | 88 | 92 | 70.34 |
| | 30 | 88 | 93.5 | 69.82 |
| | 60 | 88 | 91.4 | 70.77 |
| 11 | 0 | 70 | 75.9 | 84.04 |
| | 15 | 82 | 87.5 | 69.42 |
| | 30 | 82 | 87.4 | 68.55 |
| | 60 | 88 | 88.9 | 72.32 |
| 12 | 0 | 76 | 78.3 | 83.73 |
| | 15 | 88 | 91.1 | 69.07 |
| | 30 | 88 | 92 | 67.94 |
| | 60 | 88 | 93.2 | 67.74 |
| 13 | 0 | 76 | 76.1 | 85.16 |
| | 15 | 88 | 89 | 70.27 |
| | 30 | 88 | 89.5 | 68.45 |
| | 60 | 88 | 91.1 | 67.78 |

In Examples 14, 15 and 16, reported in Table 7, the solution of polymer in flux oil was added to the heated asphalt as a thick gel at room temperature.

TABLE 7

| | Mixing time with PPA | Pass | Fail | Phase angle |
|---|---|---|---|---|
| Example | (minutes) | (° C.) | (° C.) | (°) |
| 14 | 0 | 76 | 78.4 | 84.62 |
| | 15 | 82 | 87.7 | 71.62 |
| | 30 | 88 | 89.5 | 72.13 |
| | 60 | 88 | 90.8 | 71.1 |
| 15 | 0 | 76 | 76.3 | 84.61 |
| | 15 | 82 | 87.8 | 69.4 |
| | 30 | 82 | 87.9 | 68.69 |
| | 60 | 88 | 89.7 | 70.56 |
| 16 | 0 | 76 | 79.6 | 84.8 |
| | 15 | 82 | 89.9 | 73.95 |
| | 30 | 88 | 90 | 72.28 |
| | 60 | 88 | 90.7 | 71.24 |

The results in Table 7 support a general trend in which asphalt compositions having a higher percentage of polymer also have on average a higher DSR failure temperature. (Examples 14 and 16.) In addition, DSR failure temperature values were slightly higher with EEGMA-1 than EnBAGMA-1, although EnBAGMA-1 remains an acceptable option. (Examples 3 and 16.) Moreover, it is hypothesized that the carrier may play an important role in the concentrates, and that the Hydrolene™ oil may show a better performance compared to the ValAro oil and the DINP. (Examples 1, 2 and 6.) Finally, it is further hypothesized that the highest DSR failure temperature values may be achieved by adding the concentrate pre-heated at 140° C. Adding the concentrate as a thick gel, however, may result in a DSR failure temperature that is approximately 1° C. lower. Thus, adding the concentrate as a thick gel may remain an acceptable method of addition. Alternatively, it may be preferable to add the concentrates as a thick gel to achieve a higher DSR failure temperature. (Examples 7 and 14; Examples 6 and 15; Examples 4 and 16.)

In a different set of experiments, Table 8 describes the conditions under which one particular polymer solution (80 wt % Elvaloy® RET 5170 asphalt modifier and 20 wt % Hydrolene™ LPH) was produced by extrusion methods under different processing conditions. The extruded strands were melt-cut into pellets.

TABLE 8

| | Polymer | LPH | Inject. | Manual | | Melt | | Residual |
|---|---|---|---|---|---|---|---|---|
| Exam- | Feed Rate | Feed Rate | Temp | Output | Screw | Temp | | GMA |
| ples | (lb/hr) | (lb/min) | ° C. | (pph) | Speed | (° C.) | Vacuum | (ppm) |
| 17 | 24.00 | 0.100 | 110 | 30.30 | 250 | 163 | 15-20″ | 895 |
| 18 | 24.00 | 0.100 | 110 | 30.00 | 350 | 173 | 15-20″ | 849 |
| 19 | 24.00 | 0.100 | 110 | 29.80 | 450 | 183 | 15-20″ | 782 |
| 20 | 36.00 | 0.150 | 110 | 44.70 | 275 | 174 | 15-20″ | 1019 |
| 21 | 36.00 | 0.150 | 110 | 45.00 | 375 | 180 | 15-20″ | 1012 |
| 22 | 36.00 | 0.150 | 110 | 44.50 | 475 | 186 | 15-20″ | 891 |
| 23 | 48.00 | 0.200 | 110 | 58.70 | 300 | 177 | 15-20″ | 1083 |
| 24 | 48.00 | 0.200 | 110 | 60.60 | 400 | 182 | 15-20″ | 1034 |
| 25 | 48.00 | 0.200 | 110 | 60.00 | 500 | 187 | 15-20″ | 974 |
| 26 | 48.00 | 0.200 | 110 | 59.85 | 450 | 175 | 23-25″ | 805 |
| 27 | 48.00 | 0.200 | 110 | 59.96 | 450 | 175 | 23-25″ | 771 |
| 28 | 48.00 | 0.200 | 110 | 59.95 | 450 | 172 | 23-25″ | 907 |

In addition, the solubility of several pelletized polymer/flux oil compositions was assessed. The base asphalt sample (PEMEX EKBÉ designated Salamanca 64-22 asphalt as a base) was heated in an oven at 165° C. until it was pourable. An appropriate amount of asphalt was poured into a 1-quart stainless steel paint can as indicated in Table 9. The container was placed in a heating mantle that was temperature controlled using a thermocouple/temperature controller combination. The asphalt was mixed using an overhead stirrer equipped with a hydrofoil or pitched blade impellor at 300 rpm for about 15 minutes, until its temperature stabilized at 185° C. While maintaining the asphalt at this temperature, the designated amount of polymer/flux oil pellet was added at one time. (The polymer solution used in Examples B21, B22 and B23 was produced in Examples 26, 27 and 28, respectively.) The blend was stirred for either 10 or 20 minutes, then the asphalt composition was poured onto a piece of aluminum foil. The quality of dissolution was rated visually using the following standard: 1=no observable dissolution/deformation of the polymer/oil pellet, 3=some visible dissolution/deformation of the polymer/oil pellet, 5=full dissolution/no observable pellet. The ratings are also set forth in Table 9.

TABLE 9

| | | Wt % | Wt % | Polymer/flux | | 10 minute | 20 minute |
|---|---|---|---|---|---|---|---|
| | | EEGMA-1 | flux oil | oil pellet | Asphalt | solubility | solubility |
| Example | Flux Oil | in pellet | in pellet | amount (g) | amount (g) | (185 C.) | (185 C.) |
| Comparative | none | 100 | 0 | 1.20 | 98.80 | 1 | 1 |
| A1 | | | | | | | |
| B1 | Hydrolene ™ | 90 | 10 | 1.33 | 98.67 | 1 | 3 |
| | H50T | | | | | | |
| B2 | Hydrolene ™ | 80 | 20 | 1.50 | 98.50 | 1 | 5 |
| | H50T | | | | | | |
| B3 | Hydrolene ™ | 70 | 30 | 1.71 | 98.29 | 1 | 5 |
| | H50T | | | | | | |
| B4 | Hydrolene ™ | 60 | 40 | 2.00 | 98.00 | 5 | 5 |
| | H50T | | | | | | |
| B5 | Hydrolene ™ | 90 | 10 | 1.33 | 98.67 | 1 | 5 |
| | H90T | | | | | | |
| B6 | Hydrolene ™ | 70 | 30 | 1.71 | 98.29 | 5 | 5 |
| | H90T | | | | | | |
| B7 | Hydrolene ™ | 60 | 40 | 2.00 | 98.00 | 5 | 5 |
| | H90T | | | | | | |
| B8 | Hydrolene ™ | 60 | 40 | 2.00 | 98.00 | 5 | 5 |
| | H125T | | | | | | |
| B9 | Emery ™ | 60 | 40 | 2.00 | 98.00 | 3 | 5 |
| | 2932 | | | | | | |
| B10 | Emery ™ | 50 | 50 | 2.40 | 97.60 | 3 | 5 |
| | 2932 | | | | | | |
| B11 | Emersol ™ | 80 | 20 | 1.50 | 98.50 | 3 | 3 |
| | 3875 | | | | | | |
| B12 | Sylfat ™ DP- | 50 | 50 | 2.40 | 97.60 | 3 | 3 |
| | 8/FA-1 | | | | | | |
| B13 | Century ™ D-1 | 90 | 10 | 1.33 | 98.67 | 1 | 3 |
| B14 | Century ™ D-1 | 80 | 20 | 1.50 | 98.50 | 1 | 3 |
| B15 | Century ™ D-1 | 70 | 30 | 1.71 | 98.29 | 1 | 3 |
| B16 | Hydrobright ™ | 80 | 20 | 1.50 | 98.50 | 1 | 3 |
| | 380PO | | | | | | |
| B17 | Hydrobright ™ | 70 | 30 | 1.71 | 98.29 | 1 | 5 |
| | 380PO | | | | | | |
| B18 | Hydrolene ™ | 80 | 20 | 1.50 | 98.50 | 3 | 3 |
| | H180TN | | | | | | |
| B19 | Hydrolene ™ | 70 | 30 | 1.71 | 98.29 | 5 | 5 |
| | H180TN | | | | | | |
| B20 | Hydrolene ™ | 60 | 40 | 2.00 | 98.00 | 5 | 5 |
| | H180TN | | | | | | |
| B21 | Hydrolene ™ | 90 | 10 | 1.33 | 98.67 | 3 | 5 |
| | H600T | | | | | | |
| B22 | Hydrolene ™ | 80 | 20 | 1.50 | 98.50 | 3 | 5 |
| | H600T | | | | | | |
| B23 | Hydrolene ™ | 70 | 30 | 1.71 | 98.29 | 5 | 5 |
| | H600T | | | | | | |
| B24 | Hydrolene ™ | 60 | 40 | 2.00 | 98.00 | 5 | 5 |
| | H600T | | | | | | |

As shown in comparative example A1, the pellet containing neat polymer did not dissolve into the asphalt binder under the experimental conditions described. Examples B1 to B24 demonstrate that all compositions containing at least some combination of polymer and flux oil exhibited improved dissolution behavior under the same conditions, compared to the neat polymer A1.

The solubility of the pelletized polymer/flux oil compositions containing EEGMA-1 and Hydrolene® H600T was evaluated at different temperatures. The protocol described immediately above was followed, except that the asphalt temperature was stabilized at 145° C. and this temperature was maintained for the times indicated in Table 10 after the polymer/flux oil pellets were added. Table 11 describes the solubility of Comparative Example E1 and Examples F1 to F3 at 165° C. These samples are identical in composition to Comparative Example C1 and Examples D1 to D3. Moreover, the protocol described immediately above was followed, except that the asphalt temperature was stabilized at 165° C. and this temperature was maintained for the times indicated in Table 11 after the polymer/flux oil pellets were added.

The quality of dissolution of Comparative Example C1, Examples D1 to D3, Comparative Example E1 and Examples F1 to F2 was rated using the following standard: 1=pellet was solid, 2=pellet began dissolution but was still hard/firm, 3=the pellet exhibited some softening, 4=the pellet was deformed and in the process of dissolving, 5=full solubility/no observable pellet. These ratings are also set forth in Tables 10 and 11, in which the symbol “---” means “not measured.”

As seen in Comparative Example C1 in Table 10, the pellet containing neat polymer did not dissolve into the asphalt binder under the experimental conditions described. Examples D1 to D3 demonstrate that all compositions containing the combination of polymer and flux oil exhibited improved dissolution behavior under the same conditions.

As seen in Comparative Example E1 in Table 11, the pellet containing polymer only did not dissolve into the asphalt binder under the experimental conditions described. Examples F1 to F2 demonstrate that all compositions containing the combination of polymer and flux oil exhibited improve dissolution behavior under the same conditions as comparative example E1.

The performance of various asphalt compositions was evaluated. The base asphalt sample (PEMEX EKBÉ designated Salamanca 64-22 asphalt as a base) was heated in an oven at 165° C. until it was pourable. An appropriate amount of asphalt was poured into a 1-quart stainless steel paint can, as indicated in Table 12. The container was placed in a heating mantle that was temperature controlled using a thermocouple/temperature controller combination. The asphalt was mixed using an overhead stirrer equipped with a hydrofoil or pitched blade impellor at 300 rpm for about 15 minutes, until its temperature stabilized at at the selected reaction temperature. While maintaining the asphalt at this temperature, the designated amount of polymer/flux oil pellet was added at one time. The blend was reacted with heating alone for the time indicated in Table 12, after which a sample was taken. These samples are Control Examples G1 and G2 and Examples H1 through H8. Next, polyphosphoric acid (PPA) was added to the reaction in one addition with stirring for an additional 4 or 6 hours (i.e., 10 or 12 hours total “Sample time, after which a second sample was taken. These samples are Control Examples G3 and G4 and Examples H9 through H16.

As is set forth in Table 13, an identical set of samples was prepared by the protocol described immediately above, except that the blends were reacted with heating alone for 40 minutes only and at a different set of temperatures, after which a sample was taken. These samples are Control Examples J1 and J2 and Examples K1 through K8. Next, polyphosphoric acid (PPA) was added to the reaction in one addition with stirring for an additional 2 hours (2.67 hours total “Sample time”), after which a second sample was taken. These samples are Control Examples J3 and J4 and Examples K9 through H16.

The properties of the samples were measured using AASHTO Method No. T315 (2012) using a DSR of the model described above. The upper continuous grade temperature (PG fail), phase angle, and complex shear modulus (G*) of the samples are also set forth in Tables 12 and 13. In this connection, AASHTO M320 as that is the PG grading standard.

As demonstrated by comparative examples G1, G2, J1 and J2, the samples that were heat reacted polymer-only with no flux oil performed adequately. The performance of heat-reacted samples that included polymer/flux oil compositions was also adequate, as demonstrated by examples H1 through H8 and K1 through K8, which have performance similar to that of comparative examples G1, G2, J1 and J2. Therefore, the flux oil does not have a detrimental effect on these asphalt compositions. As demonstrated by comparative examples G3, G4, J3 and J4, the compositions comprising asphalt, polymer and PPA with no flux oil also performed adequately. The performance of heat-reacted samples that included acid and polymer/flux oil compositions was also adequate, as demonstrated by examples H9 through H16 and K9 through K16, which have performance similar to that of comparative examples G3, G4, J3 and J4. Thus, the flux oil also does not have a detrimental effect on these acid-containing asphalt compositions.

While certain of the preferred embodiments of this invention have been described and specifically exemplified above, it is not intended that the invention be limited to such embodiments. Various modifications may be made without departing from the scope and spirit of the invention, as set forth in the following claims.

TABLE 10

| | | Wt % | Wt % | Polymer/flux | | 10 minute | 20 minute |
|---|---|---|---|---|---|---|---|
| | | EEGMA-1 | flux oil | oil pellet | Asphalt | solubility | solubility |
| Example | Flux Oil | in pellet | in pellet | amount (g) | amount (g) | (145 C.) | (145 C.) |
| Comparative | none | 100 | 0 | 1.20 | 98.80 | 1 | 1 |
| C1 | | | | | | | |
| D1 | Hydrolene ™ | 90 | 10 | 1.33 | 98.67 | 2 | 4 |
| | H600T | | | | | | |
| D2 | Hydrolene ™ | 80 | 20 | 1.50 | 98.50 | 2 | 4 |
| | H600T | | | | | | |
| D3 | Hydrolene ™ | 70 | 30 | 1.71 | 98.29 | 4 | 4 |
| | H600T | | | | | | |

TABLE 11

| | | Wt % | Wt % | Polymer/flux | | 10 minute | 20 minute |
|---|---|---|---|---|---|---|---|
| | | EEGMA-1 | flux oil | oil pellet | Asphalt | solubility | solubility |
| Example | Flux Oil | in pellet | in pellet | amount (g) | amount (g) | (165 C.) | (165 C.) |
| Comparative | none | 100 | 0 | 1.20 | 98.80 | 2 | 4 |
| E1 | | | | | | | |
| F1 | Hydrolene ™ | 90 | 10 | 1.33 | 98.67 | 2 | 4 |
| | H600T | | | | | | |
| F2 | Hydrolene ™ | 80 | 20 | 1.50 | 98.50 | 4 | 5 |
| | H600T | | | | | | |

TABLE 12

| | | Wt % | Wt % | Polymer/flux | | | Reaction | | PG | Phase |
|---|---|---|---|---|---|---|---|---|---|---|
| | | EEGMA-1 | flux oil | oil pellet | Asphalt | PPA | Temperature | Sample | Fail T | Angle |
| Example | Flux Oil | in pellet | in pellet | amount (g) | amount (g) | amount (g) | (° C.) | time (h) | (° C.) | (°) |
| Comparative | None | 100 | 0 | 3.60 | 295.80 | None | 145 | 6 | 71.0 | 80.0 |
| G1 | | | | | | | | | | |
| H1 | Hydrolene ™ | 80 | 20 | 4.00 | 295.41 | None | 145 | 6 | 71.2 | 79.6 |
| | H50T | | | | | | | | | |
| H2 | Hydrolene ™ | 60 | 40 | 6.00 | 293.40 | None | 145 | 6 | 70.9 | 78.7 |
| | H50T | | | | | | | | | |
| H3 | Hydrolene ™ | 80 | 20 | 4.00 | 295.41 | None | 145 | 6 | 74.1 | 77.8 |
| | 600T | | | | | | | | | |
| H4 | Hydrolene ™ | 60 | 40 | 6.00 | 293.40 | None | 145 | 6 | 78.6 | 73.0 |
| | 600T | | | | | | | | | |
| Comparative | None | 100 | 0 | 3.60 | 295.80 | None | 185 | 6 | 77.6 | 72.6 |
| G2 | | | | | | | | | | |
| H5 | Hydrolene ™ | 80 | 20 | 4.00 | 295.41 | None | 185 | 6 | 78.0 | 74.4 |
| | H50T | | | | | | | | | |
| H6 | Hydrolene ™ | 60 | 40 | 6.00 | 293.40 | None | 185 | 6 | 75.4 | 76.0 |
| | H50T | | | | | | | | | |
| H7 | Hydrolene ™ | 80 | 20 | 4.00 | 295.41 | None | 185 | 6 | 78.9 | 73.8 |
| | 600T | | | | | | | | | |
| H8 | Hydrolene ™ | 60 | 40 | 6.00 | 293.40 | None | 185 | 6 | 78.6 | 73.0 |
| | 600T | | | | | | | | | |
| Comparative | None | 100 | 0 | 3.60 | 295.80 | 0.60 | 145 | 12 | 84.7 | 61.4 |
| G3 | | | | | | | | | | |
| H9 | Hydrolene ™ | 80 | 20 | 4.00 | 295.41 | 0.60 | 145 | 12 | 83.6 | 64.0 |
| | H50T | | | | | | | | | |
| H10 | Hydrolene ™ | 60 | 40 | 6.00 | 293.40 | 0.60 | 145 | 12 | 85.0 | 60.6 |
| | H50T | | | | | | | | | |
| H11 | Hydrolene ™ | 80 | 20 | 4.00 | 295.41 | 0.60 | 145 | 10 | 87.2 | 61.4 |
| | 600T | | | | | | | | | |
| H12 | Hydrolene ™ | 60 | 40 | 6.00 | 293.40 | 0.60 | 145 | 10 | 88.1 | 60.7 |
| | 600T | | | | | | | | | |
| Comparative | None | 100 | 0 | 3.60 | 295.80 | 0.60 | 185 | 12 | 92.0 | 61.0 |
| G4 | | | | | | | | | | |
| H13 | Hydrolene ™ | 80 | 20 | 4.00 | 295.41 | 0.60 | 185 | 12 | 91.9 | 64.6 |
| | H50T | | | | | | | | | |
| H14 | Hydrolene ™ | 60 | 40 | 6.00 | 293.40 | 0.60 | 185 | 12 | 87.6 | 67.9 |
| | H50T | | | | | | | | | |
| H15 | Hydrolene ™ | 80 | 20 | 4.00 | 295.41 | 0.60 | 185 | 10 | 91.7 | 63.2 |
| | 600T | | | | | | | | | |
| H16 | Hydrolene ™ | 60 | 40 | 6.00 | 293.40 | 0.60 | 185 | 10 | 92.2 | 61.3 |
| | 600T | | | | | | | | | |

TABLE 13

| | | Wt % | Wt % | Polymer/flux | | | Reaction | | PG | Phase |
|---|---|---|---|---|---|---|---|---|---|---|
| | | EEGMA-1 | flux oil | oil pellet | Asphalt | PPA | Temperature | Sample | Fail T | Angle |
| Example | Flux Oil | in pellet | in pellet | amount (g) | amount (g) | amount (g) | (° C.) | time (h) | (° C.) | (°) |
| Comparative | None | 100 | 0 | 3.60 | 295.80 | None | 165 | 0.67 | 70.3 | 82.6 |
| J1 | | | | | | | | | | |
| K1 | Hydrolene ™ | 80 | 20 | 4.00 | 295.41 | None | 165 | 0.67 | 69.9 | 80.9 |
| | H50T | | | | | | | | | |
| K2 | Hydrolene ™ | 60 | 40 | 6.00 | 293.40 | None | 165 | 0.67 | 69.8 | 79.7 |
| | H50T | | | | | | | | | |
| K3 | Hydrolene ™ | 80 | 20 | 4.00 | 295.41 | None | 165 | 0.67 | 70.7 | 82.3 |
| | 600T | | | | | | | | | |
| K4 | Hydrolene ™ | 60 | 40 | 6.00 | 293.40 | None | 165 | 0.67 | 71.6 | 81.3 |
| | 600T | | | | | | | | | |
| Comparative | None | 100 | 0 | 3.60 | 295.80 | None | 185 | 0.67 | 70.9 | 81.4 |
| J2 | | | | | | | | | | |
| K5 | Hydrolene ™ | 80 | 20 | 4.00 | 295.41 | None | 185 | 0.67 | 70.4 | 82.0 |
| | H50T | | | | | | | | | |
| K6 | Hydrolene ™ | 60 | 40 | 6.00 | 293.40 | None | 185 | 0.67 | 70.4 | 80.6 |
| | H50T | | | | | | | | | |
| K7 | Hydrolene ™ | 80 | 20 | 4.00 | 295.41 | None | 185 | 0.67 | 68.9 | 78.9 |
| | 600T | | | | | | | | | |
| K8 | Hydrolene ™ | 60 | 40 | 6.00 | 293.40 | None | 185 | 0.67 | 71.0 | 80.7 |
| | 600T | | | | | | | | | |
| Comparative | None | 100 | 0 | 3.60 | 295.80 | 0.60 | 165 | 2.67 | 85.6 | 60.4 |
| J3 | | | | | | | | | | |
| K9 | Hydrolene ™ | 80 | 20 | 4.00 | 295.41 | 0.60 | 165 | 2.67 | 81.9 | 63.4 |
| | H50T | | | | | | | | | |
| K10 | Hydrolene ™ | 60 | 40 | 6.00 | 293.40 | 0.60 | 165 | 2.67 | 84.8 | 60.4 |
| | H50T | | | | | | | | | |
| K11 | Hydrolene ™ | 80 | 20 | 4.00 | 295.41 | 0.60 | 165 | 2.67 | 84.8 | 62.6 |
| | 600T | | | | | | | | | |
| K12 | Hydrolene ™ | 60 | 40 | 6.00 | 293.40 | 0.60 | 165 | 2.67 | 84.0 | 63.9 |
| | 600T | | | | | | | | | |
| Comparative | None | 100 | 0 | 3.60 | 295.80 | 0.60 | 185 | 2.67 | 85.9 | 60.7 |
| J4 | | | | | | | | | | |
| K13 | Hydrolene ™ | 80 | 20 | 4.00 | 295.41 | 0.60 | 185 | 2.67 | 83.1 | 64.8 |
| | H50T | | | | | | | | | |
| K14 | Hydrolene ™ | 60 | 40 | 6.00 | 293.40 | 0.60 | 185 | 2.67 | 87.3 | 59.6 |
| | H50T | | | | | | | | | |
| K15 | Hydrolene ™ | 80 | 20 | 4.00 | 295.41 | 0.60 | 185 | 2.67 | 83.6 | 63.3 |
| | 600T | | | | | | | | | |
| K16 | Hydrolene ™ | 60 | 40 | 6.00 | 293.40 | 0.60 | 185 | 2.67 | 85.6 | 61.1 |
| | 600T | | | | | | | | | |

1. A polymer solution comprising 20 to 95 wt % of an ethylene copolymer or terpolymer comprising repeat units derived from ethylene and from an epoxy-containing comonomer, 80 to 5 wt % of a flux oil or a liquid plasticizer, and optionally 10 to 30 wt % of one or more non-reactive polymers, wherein the weight percentages are based on the total weight of the solution.

2. The polymer solution of claim 1, wherein the ethylene copolymer or terpolymer comprises repeat units derived from one or more of glycidyl acrylate, glycidyl methacrylate, glycidyl butyl acrylate, and glycidyl vinyl ether.

3. The polymer solution of claim 1, wherein the ethylene terpolymer is an ethylene vinyl acetate glycidyl methacrylate terpolymer or a copolymer of ethylene, n-butyl acrylate, and glycidyl methacrylate.

4. The polymer solution of claim 1, wherein the one or more non-reactive polymers are selected from the group consisting of styrene-butadiene copolymers and copolymers of ethylene with alkyl (meth)acrylates.

5. The polymer solution of claim 1, wherein the flux oil comprises one or more of an aromatic oil, a paraffinic oil, a mineral oil, a vegetable oil, and a shortening; and wherein the liquid plasticizer comprises one or more of a dicarboxylic ester-based plasticizer, a tricarboxylic ester-based plasticizer, an acetic acid ester of a monoglyceride, a trimellitate, an adipate, a benzoate, an adipic acid polyester, a polyetherester, an epoxy ester, or a maleate.

6. The polymer solution of claim 5, wherein the liquid plasticizer comprises one or more of bis(2-ethylhexyl) phthalate, di-octyl phthalate, diisononyl phthalate, and diisodecyl phthalate.

7. An asphalt composition comprising or produced from asphalt and about 0.01 to about 10 weight % of the polymer solution of claim 1; optionally about 0.001 to about 5 weight % of a sulfur source; and optionally about 0.001 to about 10 weight % of an acid, wherein the weight percentages are based on the total weight of the asphalt composition.

8. The asphalt composition of claim 7, comprising or produced from about 0.5 to about 8 weight % of the polymer solution.

9. The asphalt composition of claim 7, comprising or produced from about 0.5 to about 4 weight % of the polymer solution.

10. The asphalt composition of claim 9, comprising or produced from about 0.005 to about 2 weight % of the sulfur source or about 0.005 to about 2 weight % of the acid.

11. The asphalt composition of claim 7, wherein the ethylene copolymer or terpolymer comprises copolymerized repeat units of ethylene and copolymerized repeat units of glycidyl methacrylate.

12. A method for preparing a polymer modified asphalt, said method comprising the steps of:
(1) combining the ethylene copolymer or terpolymer, the flux oil or liquid plasticizer, and the optional additional polymer(s) in an extruder to provide the polymer solution of claims 1; and
(2) mixing the polymer solution with asphalt.

13. A road pavement or roofing sheet comprising an asphalt composition according to claim 7.

14. The road pavement or roofing sheet of claim 13, wherein the asphalt composition comprises or is produced from about 0.01 to about 6 weight % of the ethylene copolymer or terpolymer; the ethylene copolymer or terpolymer comprises compolymerized repeat units of one or more of glycidyl acrylate, glycidyl methacrylate, glycidyl butyl acrylate, and glycidyl vinyl ether; the flux oil comprises one or more of an aromatic oil, a paraffinic oil, a mineral oil, and a vegetable oil; and the liquid plasticizer comprises one or more of a dicarboxylic ester-based plasticizer, a tricarboxylic ester-based plasticizer, an acetic acid ester of a monoglyceride, a trimellitate, an adipate, a benzoate, an adipic acid polyester, a polyetherester, an epoxy ester, or a maleate.

15. The road pavement or roofing sheet of claim 14, wherein the the ethylene copolymer or terpolymer comprises compolymerized repeat units of glycidyl methacrylate; the flux oil comprises one or more of anaromatic oil, a paraffinic oil, and a mineral oil; the liquid plasticizer comprises one or more of bis(2-ethylhexyl) phthalate, di-octyl phthalate, diisononyl phthalate, and diisodecyl phthalate; and wherein the asphalt composition comprises or is produced from an acid or about 0.005 to about 2 weight % of at least one sulfur source selected from the group consisting of elemental sulfur, a sulfur donor, and a sulfur byproduct.
